(19) United States
(12) Patent Application Publication
(10) Pub. No.: US 2025/0065477 A1
(43) Pub. Date: Feb. 27, 2025

(54) Knock-on Wheel Weight Installation and Removal Tool

(71) Applicant: Gaither Tool Company, Inc., Jacksonville, IL (US)

(72) Inventor: David W. Teal, Holladay, UT (US)

(73) Assignee: Gaither Tool Company, Inc., Jacksonville, IL (US)

(21) Appl. No.: 18/812,942

(22) Filed: Aug. 22, 2024

Related U.S. Application Data
(60) Provisional application No. 63/534,309, filed on Aug. 23, 2023.

(51) Int. Cl. B25B 27/00

(52) U.S. Cl. CPC B25B 27/0078

(57) ABSTRACT

A knock-on wheel weight tool for installing or removing a wheel weight with a metal clip on a wheel rim. The knock-on wheel weight tool includes a shaft component, a wheel-weight installation head removably attached to the shaft component, the wheel-weight installation head including a wheel weight clip contact area shaped to receive the metal clip of the wheel weight. The knock-on wheel weight tool also includes a weighted slide handle with a shaft hole sized to receive the shaft component, allowing the weighted slide handle to slide back and forth on the shaft component. A user slides the weighted slide handle along the shaft component to strike the wheel-weight installation head which in turn snaps the metal clip of the wheel weight onto the wheel rim.

### CROSS-REFERENCE TO RELATED APPLICATIONS

The present application claims priority from, and incorporates by reference in its entirety, U.S. provisional patent application 63/534,309 filed Aug. 23, 2023.

### BACKGROUND

### Field of the Invention

Various embodiments of the present invention relate to tools, and more specifically, to automotive hand tools.

### Description of Related Art

Car and truck tires must be balanced to perform optimally. A tire that is out of balance tire can cause vibration, poor handling and shorten the life of the tires, bearings and other components of the vehicle's suspension. Balanced tires improve the safety and comfort of the vehicle ride, help to increase fuel mileage, and make tires last longer.

Wheel weights are used to balance car and truck tires in automotive repair shops, tire shops, and auto body shops. FIG. 1A depicts conventional knock-on wheel weight 901. Wheel weight 901 must be securely fastened to the wheel 920 to ensure it doesn't come loose while the vehicle is traveling, potentially becoming a dangerous projective. Knock-on wheel weight 901 typically has a metal clip 903 attached to a lead weight 905. The metal clip 903 of various brands and models of wheel weights make have slightly different shapes because different types of wheel rims have different cross-sectional shapes. There are a number of metal clip shapes, each designed to fit the particular wheel rim shape. But they all snap on and off the wheel rims in the same manner. The metal clip 903 snaps tightly onto the edge of the wheel 920, as shown in FIG. 1B. This holds the lead weight 905 securely in place against the rim of the wheel. Typically, a user such as a mechanic or service technician uses a hammer or plastic mallet 919 to tap the knock-on wheel weight 901 into place on the wheel rim 920, as shown in FIG. 1C.

### BRIEF SUMMARY

The present inventor recognized a need for a customized wheel weight tool, making it easier to install and remove knock-on wheel weights without damaging or scratching the wheel, or injuring the mechanics fingers. The various embodiments disclosed herein achieve these objectives, as discussed in the paragraphs below and illustrated in the drawings.

Various embodiments disclosed herein are drawn to a knock-on wheel weight tool for installing or removing a wheel weight with a metal clip on a wheel rim. In various embodiments the knock-on wheel weight tool includes a shaft component that has first and second ends and a shaft diameter, and a wheel-weight installation head that is removably attached to the first end of the shaft component. The wheel-weight installation head includes a wheel weight clip contact area shaped to receive the metal clip of the wheel weight. The various embodiments also include a weighted slide handle configured with a shaft hole through a longitudinal length of the weighted slide handle, the shaft hole having a hole diameter at least 0.5% greater than the shaft diameter. The weighted slide handle is typically configured to receive the shaft component to extend through the shaft hole.

In various embodiments the knock-on wheel weight tool includes a stationary handle section affixed to the second end of the shaft component, and a wheel-weight removal hook head that is removably attached to the second end of the shaft component. In various embodiments the weighted slide handle is configured to slide back and forth on the shaft component and exert a force equal to or greater than a clip installation force on the wheel-weight installation head to snap the metal clip of the wheel weight onto the wheel rim.

### DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A depicts a front view and top view of a conventional knock-on wheel weight.

FIG. 1B depicts a cross-sectional view of a conventional knock-on wheel weight snapped on a wheel rim.

FIG. 1C depicts a knock-on wheel weight being fastened to the rim of a wheel in a conventional manner using a mallet.

FIG. 2A is an oblique view depicting a knock-on wheel weight installation/removal tool, according to various embodiments.

FIG. 2B is an oblique view depicting a wheel-weight installation head, according to various embodiments.

FIG. 3 is an exploded side view depicting a knock-on wheel weight installation/removal tool, according to various embodiments.

FIG. 4A is a cross-sectional side view depicting a wheel-weight removal hook head, according to various embodiments.

FIG. 4B is a cutaway cross-sectional side view depicting the hook tip of a wheel-weight removal hook head, according to various embodiments.

FIG. 5A is a side view depicting a weighted slide handle, according to various embodiments.

FIG. 5B is a side view depicting a stationary handle section, according to various embodiments.

FIG. 6A is a side view depicting an electric wheel weight installation device, according to various embodiments.

FIG. 6B is a side view depicting a pneumatic wheel weight installation device, according to various embodiments.

### DETAILED DESCRIPTION

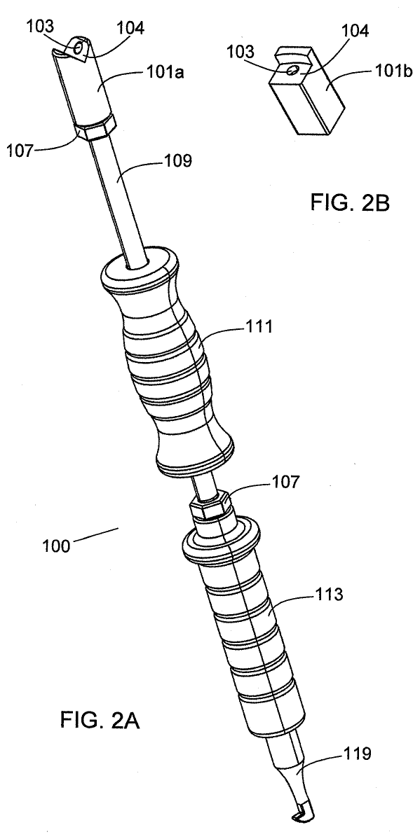

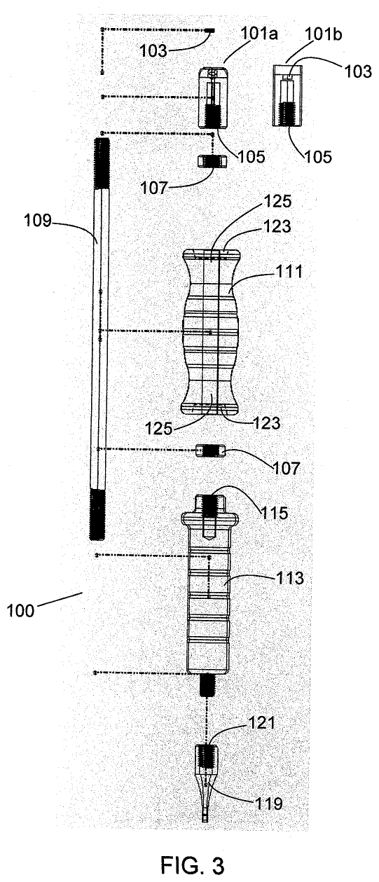

FIG. 2A is an oblique view depicting a knock-on wheel weight installation/removal tool 100, according to various embodiments. FIG. 3 is an exploded side view of the knock-on wheel weight installation/removal tool 100, according to various embodiments. The knock-on wheel weight installation/removal tool 100—sometimes simply called a wheel weight tool 100—has a shaft component 109 with a wheel-weight installation head 101a mounted at one end and a wheel-weight removal hook head 119 mounted on the other end. The shaft component 109 is typically threaded at each end with male threads which correspond to the female threads of wheel-weight installation head 101a and the wheel-weight removal hook head 119. In various embodiments the shaft component 109 is at least 5 inches long but no greater than 18 inches long. In some embodiments the shaft component 109 is 9+/−4 inches long. In some embodiments the shaft component 109 is at least 5 inches long. A threaded nut 107 is tightened against the installation head 101a to secure it firmly on the shaft component 109. Another threaded nut 107 is tightened against the wheel-weight removal hook head 119 to secure it firmly on the shaft component 109 as well.

A weighted slide handle 111 is configured to slide back and forth on shaft component 109. The shaft component 109 is affixed to a stationary handle section 113 located towards one end of the wheel weight tool 100. The stationary handle section 113 can be positioned at either end. FIG. 2A shows the embodiment with the stationary handle section 113 positioned towards the end with the wheel-weight removal hook head 119—the removal end of tool 100. In other embodiments the stationary handle section 113 may be positioned towards the wheel-weight installation head 101a/b—the installation end of tool 100.

FIG. 2B is an oblique view depicting a wheel-weight installation head 101b, according to various embodiments. The wheel-weight installation head 101a and 101b are removably attached to the shaft component 109. As shown in the figure, the shaft component 109 has a male threaded end, and the wheel-weight installation head 101a and 101b each have a female threaded hole that screws onto the threaded end of shaft component 109. Various kinds of wheels have differing rim shape profiles, and different brands of knock-off wheel weights may have slightly differing shapes themselves. Thus, wheel-weight installation head 101a may work better on some wheels or wheel weights, while wheel-weight installation head 101b may work better on others. Both of the wheel-weight installation heads 101a/b have a wheel-weight clip contact area 104 on their distal end which is shaped to receive the metal clip 903. That is, the wheel-weight clip contact area 104 is shaped so the metal clip 903 fits on it in order to pop the metal clip 903 into place.

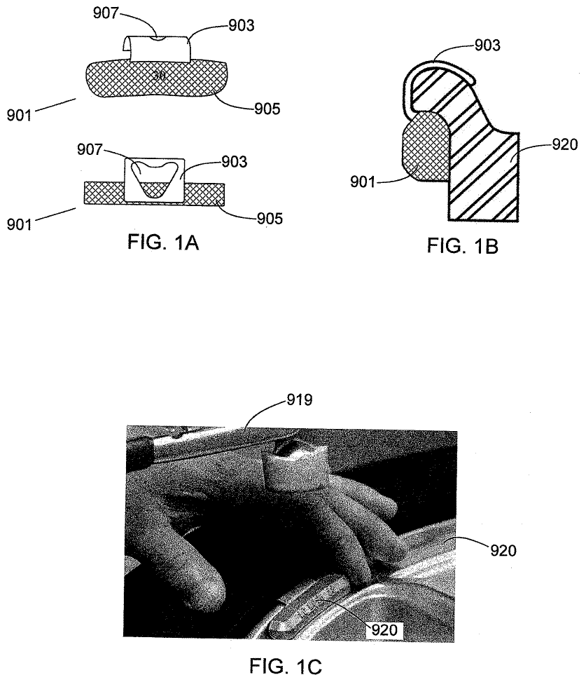

The wheel-weight installation heads 101a and 101b may be equipped with clip magnets 103 embedded in the clip contact area 104 to temporarily hold the knock-on wheel weight to the wheel-weight installation heads 101a and 101b during installation. Mechanics installing knock-on wheel weights using a hammer or mallet must hold the weight in place while tapping on it with the hammer or mallet. Since there isn't much clearance between the wheel weight and the rim, using a hammer often results in either injured fingers or a scratched rim. This can be prevented through use of the various embodiments of the disclosed invention. The wheel weight may be pressed firmly against the rim by the shaft component 109 and install head 101a (or 101b). The clip magnet 103 aids in keeping the wheel weight in place while positioning the wheel weight tool 100. The clip magnet 103 attracts the steel clip 903 of wheel weight 901 shown in FIG. 1A.

Tire installation is achieved by positioning a wheel weight 901 on the rim where it is to be installed. The user grasps the knock-on wheel weight installation/removal tool 100 with one hand on stationary handle section 113 and the other hand on weighted slide handle 111. He then places the wheel-weight installation head 101a (or 101b) against the wheel weight 901, keeping it pressed in place with a slight amount of pressure, with the weighted slide handle 111 drawn back towards the removal end. The user thrusts the weighted slide handle 111 forward on shaft component 109, driving it into the threaded nut 107 which is tightened against wheel weight installation head 101a. The force of the weighted slide handle 111 hitting the threaded nut 107 and installation head 101a causes the metal clip 903 knock-on wheel weight 901 to snap into place.

There is often a need to remove a knock-on wheel weight 901—e.g., when the tires are being replaced or if the wheel is being rebalanced. To remove a knock-on wheel weight 901 the user again grasps the knock-on wheel weight installation/removal tool 100 with one hand on the stationary handle section 113 and the other hand on weighted slide handle 111. The user places the hook of the wheel-weight removal hook head 119 into clip hole 907 of wheel weight 901 so the hook catches on the metal clip 903 with the weighted handle 111 slid forward towards the hook end of the knock-on wheel weight installation/removal tool 100. He then slides the weighted handle 111 rapidly away from the wheel, slamming it against the threaded nut 107 and stationary handle section 113. The force of the weighted handle 111 hitting the threaded nut 107/stationary handle section 113 causes the metal clip 903 to pop off of the rim, removing the knock-on wheel weight 901 from the wheel.

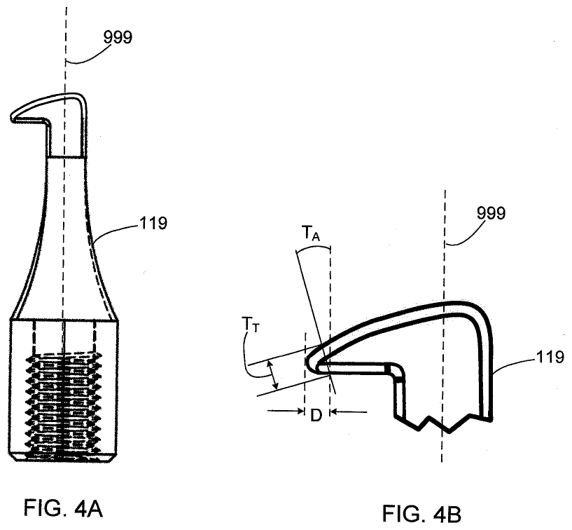

FIG. 4A is a cross-sectional side view of a wheel-weight removal hook head 119, according to various embodiments. The wheel-weight removal hook head 119 and the wheel weight installation heads 101a/b each have a head thread section 105 that allows for attachment and removal of the respective heads 119, 101a and 101b. In the embodiments depicted the head thread section 105 is female threads that accept a male threaded portion. The head thread section 105 of wheel-weight removal hook head 119 accepts a male threaded portion of shaft component 109. The head thread section 105 of wheel weight installation heads 101a/b a male threaded portion of stationary handle section 113. This can be seen in FIG. 3.

In other embodiments the wheel-weight removal hook head 119 and/or the wheel weight installation heads 101a/b may be configured with a male threaded head thread section 105. In such embodiments the connecting parts—that is, the shaft component 109 and the stationary handle section 113 are configured with corresponding female threaded sections that removably attach to the male threaded head thread section 105 of the wheel-weight removal hook head 119 and/or the wheel weight installation heads 101a/b.

Turning back to FIG. 2A, the nut 107 is threaded onto shaft component 109 ahead of the wheel-weight removal hook head 119. After the removal hook head 119 is threaded onto shaft component 109, the nut 107 is tightened down against the hook head 119 to lock it in place. In some implementations a lock washer may be positioned between hook head 119 and nut 107. Similarly, a nut 107 is threaded onto shaft component 109 ahead of stationary handle section 117. The nut 107 is tightened against the stationary handle section 117 to lock it in place. A lock washer may also optionally be placed between nut 107 and stationary handle section 117. Since the wheel-weight removal hook head 119 and installation heads 101a/b use male/female threads for attachment, they can easily be removed to replace a damaged head or use a head with a different shape for a particular wheel rim profile.

FIG. 4B is a cutaway cross-sectional side view depicting the hook tip of a wheel-weight removal hook head 119, according to various embodiments. There are a number of different shaped clip holes in the metal clips of various different brands and types of wheel weights. FIG. 1A shows one common shape of a clip hole 907. Other holes may be oval, slotted, or another complex shape. The present inventor has determined an optimal shape of a hook tip for a wheel-weight removal hook head 119 that fits into the majority of different sized and shaped clip holes 907.

Referring to FIG. 4B, the optimal tip shape is defined by the thickness of the tip measured a distance T_{T} in from the outermost point, as measured at an angle T_{A} downward from horizontal, and by the radius of the curve at the tip point. The thickness of the tip T_{T} is measured a distance D=0.125 inch inward from the outermost point that the tip extends away from the centerline 999 of wheel-weight removal hook head 119. However, the tip thickness is not measured straight up-and-down (parallel to centerline 999) since this would result in a tip thickness T_{T} slightly larger than the effective tip thickness of the wheel weight installation/removal tool 100 being held at an angle so as to push the tip in as far in as possible. The removal hook tip thickness T_{T} is measured at 15 degrees below horizontal—that is, below the line perpendicular to the centerline 999. A typical value for the removal hook tip thickness T_{T} measured in this manner is 0.150 inch+/−0.075 inch. Some implementations designed for larger sized slot holes 907 have a removal hook tip thickness T_{T} of 0.250 inch+/−0.100 inch. Other implementations have a removal hook tip thickness T_{T} of no greater than 0.225 inch. The optimal radius of the curve at the tip point is no greater than 0.0625 inch, in accordance with various embodiments.

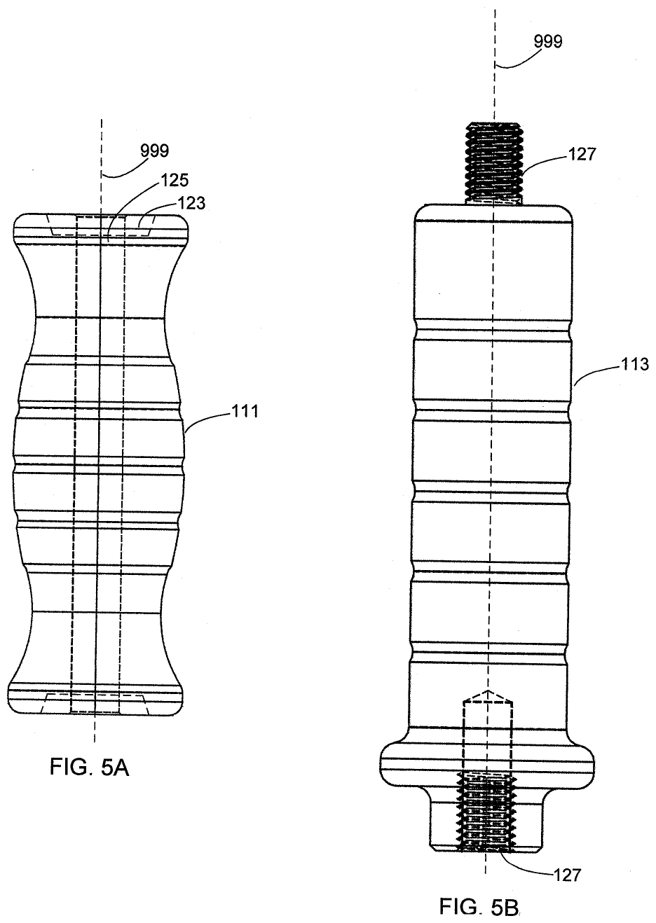

FIG. 5A is a side view depicting a weighted slide handle 111, according to various embodiments. The weighted slide handle 111 has a shaft hole 125 passing through its length of a size so as to permit the shaft component 109 to pass through. The shaft hole 125 is slightly larger than the diameter of shaft component 109, allowing it to slide back and forth freely with little friction. In some embodiments the shaft hole 125 has a diameter at least 0.5% larger than the diameter of the shaft. The shaft hole 125 is typically concentric with centerline 999 which passes through the center of weighted slide handle 111. In some implementations the shaft hole 125 may be offset from centerline 999, or the weighted slide handle 111 may be non-symmetrical and lack a true centerline 999.

The weighted slide handle 111 has sufficient weight to exert a force equal to or greater than a clip installation force required to snap the metal clip 903 of a wheel weight 901 onto a wheel rim in response to delivering a blow. The clip installation force is generated and delivered to the wheel weight installation head 101a/b by the user grasping the weighted slide handle 111 and slamming it into the wheel weight installation head 101a/b via the threaded nut 107. That is, the force from the collision between the weighted slide handle 111 and the threaded nut 107 is passed through threaded nut 107 to the wheel weight installation head 101a/b. To deliver the requisite clip installation force the weighted slide handle 111 is preferably of sufficient weight. The weighted slide handle 111 typically weights from 0.75 to 5.0 lbs. In various implementations the weighted slide handle 111 weighs 2.50+/−1.50 lbs. In other implementations the weighted slide handle 111 weighs 2.10+/−1.40 lbs. In some implementations the weighted slide handle 111 weighs no greater than 6.5 lbs.

The weighted slide handle 111 may be configured with a contact area cavity 123 of sufficient size to allow the nut 107 to fit at least partially in. It has been noted by the present inventor that having a contact area cavity 123 helps to prevent pinched fingers. The user is more likely to notice that their fingers have stray over the a contact area cavity 123 than if the ends of weighted slide handle 111 are simply flat up to the center hole 125 which contains shaft component 109. The contact area cavity 123 is typically at least half as deep as the nut 107 is thick, and has a diameter at least 0.125 inches greater than the diameter of the nut 107 as defined by the outermost points from the centerline 999 passing through the nut 107. The weighted slide handle 111 is typically configured with a contact area cavity 123 at both longitudinal ends (i.e., the long ways ends). The longitudinal ends may be referred to as the insertion end which is oriented towards the wheel weight installation head 101a/b and the removal end which is oriented towards the wheel-weight removal hook head 119.

FIG. 5B is a side view depicting the stationary handle section 113, according to various embodiments. One end of the stationary handle section 113 connects to shaft component 109 and the other end connects to the wheel-weight removal hook head 119. In various embodiments, the stationary handle section 113 has male threads at one end—like a bolt ending from the end, and a hole with female threads at the other end. Typically the male threads connect to the wheel-weight removal hook head 119 and the female threads connect to shaft component 109. However, in some implementations female threads may be used to connect to wheel-weight removal hook head 119. Similarly, in some implementations male threads may be used to connect to shaft component 109. The threads, both male and female are typically concentric to centerline 999. In some implementations the male threads and/or the female threads may be offset from center, or the stationary handle section 113 may be non-symmetrical and lack a true centerline 999.

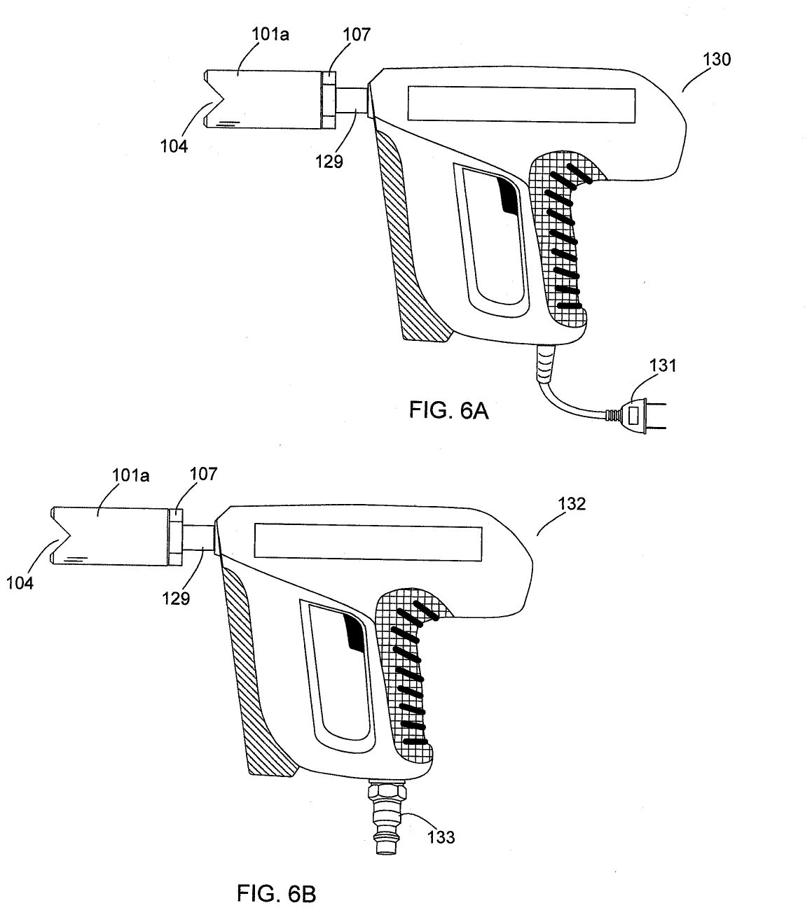

FIG. 6A is a side view depicting an electric wheel-weight installation device 130, according to various embodiments. FIG. 6B is a side view depicting a pneumatic wheel weight installation device 132, according to various embodiments. Both wheel weight installation devices 130-132 include a wheel weight installation head 101a connected to a push rod 129. The push rod 129 is typically male threaded in the same manner as shaft component 109 shown in FIGS. 2A and 3. A nut 107 is tightened against wheel weight installation head 101a to lock it securely onto push rod 129. The wheel weight installation head 101a includes a wheel-weight clip contact area 104 on its distal end which is shaped to receive the metal clip 903 of a wheel weight 901. The wheel-weight clip contact area 104 is shaped so the metal clip 903 fits on it in order to pop the metal clip 903 into place when force from contact is applied.

The electric wheel-weight installation device 130 may include a solenoid mechanism that drives the push rod 129 outward to seat a wheel weight 901 on a wheel rim. Typically, the electric wheel-weight installation device 130 operates off of standard 110-120 volts (V) at 60 hertz (Hz). A standard electrical plug 131 is provided on the tool. For specialized applications 220 volts, or another available voltage—either AC or DC—may be used. The pneumatic wheel weight installation device 132 may include an air driven piston that drives the push rod 129 outward to seat a wheel weight 901 on a wheel rim. A standard quick release air coupler 133 may be provided to accept high pressure air from a source such as an air compressor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.”

The descriptions and explanations in this disclosure discusses a threaded section (e.g., of a threaded shaft) that “corresponds” to the threaded section of another component such as a nut. The term “corresponds” (or “corresponding”) in this context means that the threads of the nut match those of the shaft, allowing the nut with female threads to be screwed onto the male threads of the threaded shaft.

The description of the various embodiments provided above is illustrative in nature inasmuch as it is not intended to limit the invention, its application, or uses. Thus, variations that do not depart from the intents or purposes of the invention are intended to be encompassed by the various embodiments of the present invention. Such variations are not to be regarded as a departure from the intended scope of the present invention.

What is claimed is:

1. A knock-on wheel weight apparatus for installing a wheel weight with a metal clip on a wheel rim, the apparatus comprising:
a shaft component including a first end and a second end, the shaft component having a shaft diameter;
a wheel-weight installation head removably attached to the first end of the shaft component, the wheel-weight installation head including a wheel weight clip contact area shaped to receive the metal clip of the wheel weight;
a weighted slide handle configured with a shaft hole through a longitudinal length of the weighted slide handle, the shaft hole having a hole diameter at least 0.5% greater than the shaft diameter, the weighted slide handle being configured to receive the shaft component to extend through the shaft hole;
a stationary handle section affixed to the second end of the shaft component; and
a wheel-weight removal hook head removably attached to the second end of the shaft component;
wherein the weighted slide handle is configured to slide back and forth on the shaft component and exert a force equal to or greater than a clip installation force on the wheel-weight installation head to snap the metal clip of the wheel weight onto the wheel rim.

2. The apparatus of claim 1, wherein the shaft component includes a first threaded section at the first end and a second threaded section at the second end; and
wherein the wheel-weight installation head includes a third threaded section that corresponds to the first threaded section of the shaft component; and
wherein the stationary handle section includes a fourth threaded section that corresponds to the second threaded section of the shaft component.

3. The apparatus of claim 2, wherein the first threaded section and the second threaded section include male threads; and
wherein the third threaded section of the wheel-weight installation head and the fourth threaded section of the stationary handle section include female threads.

4. The apparatus of claim 3, further comprising:
a first threaded nut positioned on the first threaded section of the shaft component between the wheel-weight installation head and the weighted slide handle, wherein the first threaded nut is tightened against the wheel-weight installation head.

5. The apparatus of claim 4, further comprising:
a second threaded nut positioned on the second threaded section of the shaft component between the stationary handle section and the weighted slide handle, wherein the second threaded nut is tightened against the stationary handle section.

6. The apparatus of claim 5, wherein the weighted slide handle weighs 2.50+/−1.50 pounds; and
wherein the shaft component is at least 5.0 inches long.

7. The apparatus of claim 6, further comprising:
a distal end of the wheel-weight installation head, the distal end including a weight clip contact area shaped to receive the metal clip of the wheel weight.

8. The apparatus of claim 7, further comprising:
a clip magnet embedded in the weight clip contact area of the wheel-weight installation head, the clip magnet being positioned to hold the metal clip of the wheel weight to the wheel-weight installation head prior to installation on the wheel rim.

9. The apparatus of claim 8, further comprising:
a removal tip of the wheel-weight removal hook head, the removal tip having a tip thickness;
a fifth threaded section of female threads included as part of the wheel-weight removal hook head; and
a centerline bisecting the fifth threaded section.

10. The apparatus of claim 9, wherein the tip thickness of the removal tip is measured 0.125 inch inward from a point on the removal tip furthest from the centerline, and at an angle of 15 degrees from perpendicular to the centerline, the 15 degrees being away from a distal end of the removal tip.

11. The apparatus of claim 9, further comprising:
an insertion end on the wheel-weight installation head and a removal end on the wheel-weight installation head;
a first contact area cavity at the insertion end of the wheel-weight installation head; and
a second contact area cavity at the removal end of the wheel-weight installation head.

12. The apparatus of claim 9, wherein the first threaded nut and the second threaded nut have a nut thickness of at least 0.375 inch; and
wherein the first contact area cavity and the second contact area cavity have a depth at least half as deep as the nut thickness.
